(19) United States
(12) Patent Application Publication
(10) Pub. No.: US 2002/0060283 A1
(43) Pub. Date: May 23, 2002

(54) Natural light metering and augmentation device

(76) Inventors: Geoffrey A. Jordan, Oklahoma City, OK (US); Gregory S. Dunne, Baulkam Hills (AU)

Correspondence Address: Dunlap, Codding & Rogers, P.C., Attention: Marc A. Brockhaus, Suite 420, 9400 North Broadway, Oklahoma City, OK, 73114, US

(21) Appl. No.: 09/975,426

(22) Filed: Oct. 11, 2001

Related U.S. Application Data
(63) Continuation-in-part of application No. 09/198,773, filed on Nov. 24, 1998, now abandoned.

(51) Int. Cl. G01J 1/32

(52) U.S. Cl. 250/205

(57) ABSTRACT

A natural light metering and augmentation device for maintaining at least a predetermined minimum level of illumination in a building area. Broadly, the device comprises a skylight, a light sensor, an artificial light source, and a control circuit. The skylight is positioned to receive natural light and to discharge the natural light into the building area. The light sensor is capable of sensing the level of natural light received into the skylight and of outputting a signal indicative of the level of natural light received into the skylight. The artificial light source is provided with a variable light level output. The artificial light source is positioned to selectively discharge artificial light into the building area. Finally, the control circuit is adapted to receive the signal indicative of the level of natural light received into the skylight and to selectively regulate the level of artificial light generated by the artificial light source to maintain the combined natural light and artificial light discharged into the building area at a level substantially corresponding to the predetermined minimum level when the natural light received into the skylight falls below the predetermined minimum level.

### CROSS-REFERENCE TO RELATED APPLICATIONS

This is application is a continuation in part of Ser. No. 09/198,773, the entire content of which is hereby incorporated by reference.

### BACKGROUND OF THE INVENTION

Building areas exist which need to be maintained for long periods of time at a minimum predetermined light level. For example, building areas, such as restrooms, kitchens, or offices in restaurants need to remain illuminated at the minimum predetermnined light level for long periods of time so that people can enter and/or work in such areas. However, maintaining these areas at a constant predetermined minimum light level with artificial light is expensive.

To reduce these costs, a need exists for a device which reliably maintains the building area at the predetermined minimum light level while also reducing the costs associated therewith. It is to such a device that the present invention is directed.

### BRIEF SUMMARY OF THE INVENTION

The present invention is a natural light metering and augmentation device for maintaining at least a predetermined minimum level of illumination in a building area. Broadly, the device comprises a skylight, a light sensor, an artificial light source, and a control circuit.

The skylight is positioned to receive natural light and to discharge the natural light into the building area. The light sensor is capable of sensing the level of natural light received into the skylight and of outputting a signal indicative of the level of natural light received into the skylight. The artificial light source is provided with a variable light level output. The artificial light source is positioned to selectively discharge artificial light into the building area. Finally, the control circuit is adapted to receive the signal indicative of the level of natural light received into the skylight and to selectively regulate the level of artificial light generated by the artificial light source to maintain the combined natural light and artificial light discharged into the building area at a level substantially corresponding to the predetermined minimum level when the natural light received into the skylight falls below the predetermined minimum level.

Thus, it can be seen that the present invention only illuminates the artificial light source once the natural light received into the skylight falls below the predetermined minimum level and variably controls the illumination of the artificial light source so as to maintain the combined natural light and artificial light discharged into the building area at a level substantially corresponding to the predetermined minimum level. Thus, it can be seen that the present invention reduces the costs associated with maintaining the light in the building area to at least the minimum predetermined level by discharging natural light into the building area, and then augmenting with the artificial light source the deficiency between the minimum predetermined level and the natural light received into the skylight.

Other features and advantages of the present invention will become apparent to those skilled in the art when the following description is read in conjunction with the attached drawings and appended claims.

### BRIEF DESCRIPTION OF THE DRAWINGS

FIG. 1 is a perspective view of a natural light metering and augmentation device constructed in accordance with the present invention.

FIG. 2 is a chart which illustrates the natural light, artificial light, and combined natural and artificial light outputs of the device depicted in FIG. 1 for a 24-hour day.

FIG. 3 is a table summarizing the relationships of the natural light, artificial light, and combined natural and artificial light output by the device depicted in FIG. 1 for a 24-hour day.

FIG. 4 is a block diagram illustrating a control circuit constructed in accordance with the present invention.

FIG. 5 is a schematic diagram of the control circuit depicted in FIG. 4.

FIG. 6 is a front elevational view of a second embodiment of a natural light metering and augmentation device constructed in accordance with the present invention.

### DETAILED DESCRIPTION OF THE INVENTION

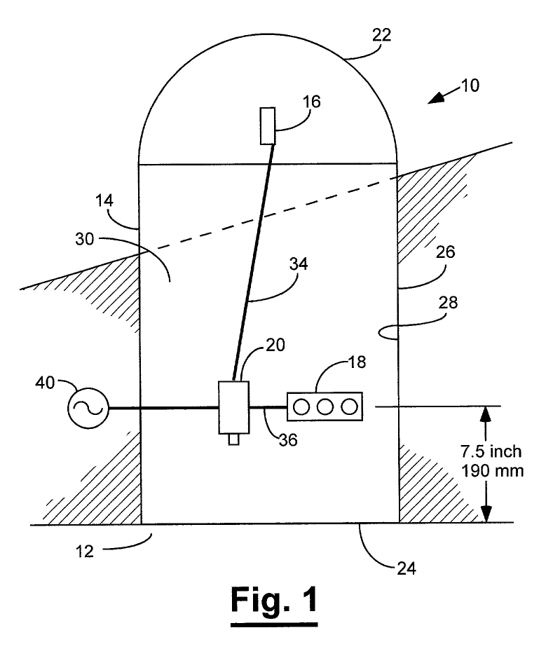

Referring now to the drawings, and in particular to FIG. 1, shown therein and designated by the general reference numeral 10 is a natural light metering and augmentation device constructed in accordance with the present invention. The device 10 is adapted and constructed to maintain at least a predetermined minimum level of illumination in a building area 12. The building area 12 can be a building area, such as a restroom or kitchen.

The device 10 includes a skylight 14, a light sensor 16, an artificial light source 18, and a control circuit 20. It should be noted that more than one device 10 can be disposed in a same building area 12 such that each of the devices 10 operates independently of the other devices 10.

The skylight 14 has a first end 22, an opposed second end 24, a continuous sidewall 26 extending between the first end 22 and the second end 24, and a light transmitting assembly 28. The light transmitting assembly 28 can be a reflective surface formed on the interior of the sidewall 26. The light transmitting assembly 28 is disposed in a receiving 3 space 30 defined by the continuous sidewall 26, and serves to transmit light received into the first end 22 of the skylight 14 to the second end 24 thereof. Once the light is received at the second end 24 of the skylight 14, such light is discharged into the building area 12. The skylight 14 can be a “Solatube”brand skylight.

The light sensor 16 is disposed in the receiving space 30 of the skylight 14 and serves to sense the level of natural light received into the skylight 14 through the first end 22 thereof from a natural light source, such as the sun. The light sensor 16 generates a signal indicative of the level of the natural light received into the skylight 14 and outputs the signal over a signal path 34.

The artificial light source 18 is adapted and constructed to have a variable light level output. In general, the artificial light source 18 is positioned to selectively discharge artificial light into the building area 12. As shown in FIG. 1, the artificial light source 18 can be disposed in the receiving space 30 of the skylight 14. The artificial light source 18 can be one lamp, or multiple lamps connected in parallel. The lamps forming the artificial light source 18 may be incandescent (tungsten or halogen), or a dimmable compact fluorescent lamp, and combinations thereof. When the artificial light source 18 includes a dimmable compact fluorescent lamp, the dimmable compact fluorescent lamp can be an “EARTHLIGHT®” brand dimmable compact fluorescent lamp obtainable from Philips.

The control circuit 20 is adapted to receive the signal generated and output by the light sensor 16. In response thereto, the control circuit 20 regulates the level of artificial light generated by the artificial light source 18 via a signal path 36 so as to immediately maintain the combined natural light and artificial light discharged into the building area 12 at a level substantially corresponding to the predetermined minimum level when the natural light received into the skylight 14 falls below the predetermined minimum level. In one embodiment, the control circuit 20 receives electrical power from a power source 40, and continuously regulates the magnitude or the phase of the power transmitted to the artificial light source 18 via the signal path 36 to substantially instantaneously control the level of artificial light generated by the artificial light source 18. The power source 40 can be 110-120 VAC having a frequency of 60 Hz, and the power transmitted to the artificial light source 18 over the signal path 36 can be 0-120 VAC having a frequency of 60 Hz.

The control circuit 20 includes at least three modes of operation when controlling the level of the light generated by the artificial light source 18. In the first mode, the artificial light source 18 includes one or more incandescent lamps are connected in parallel (if more than one lamp is utilized) such that the total load is greater than 23 watts but less than 200 watts. Light control will be infinitely adjustable from zero to maximum light output.

In the second mode, the artificial light source 18 includes one or more dimmable compact fluorescent lamps connected in parallel (if more than one dimmable compact fluorescent lamp is utilized), such that the total load is greater than 23 watts but less than 200 watts. Light control will be infinitely adjustable from approximately 20% to maximum light output. It should be noted that if two or more dimmable lamps are connected in parallel, the minimum light output of the lamps may not be coincident. This effect is due to the slightly different turn on voltage of each lamp.

In the third mode, the artificial light source 18 includes a combination of incandescent and dimmable compact fluorescent lamps connected in parallel such that the total load is greater than 23 watts but less than 200 watts. Light control will be infinitely adjustable from zero to maximum light output. The third mode of operation may be appropriate if the blended color temperature of the incandescent and dimmable compact fluorescent lamps is considered more pleasing to the eye.

The highest energy efficient operation mode is the second mode, with one or more dimmable fluorescent lamps. That is, a single 23-watt dimmable compact fluorescent lamp gives the equivalent level of light of a 90-watt incandescent lamp. It follows that the third mode is the next most energy efficient mode. The first mode is the least efficient. The second mode is almost four times more efficient than the first mode.

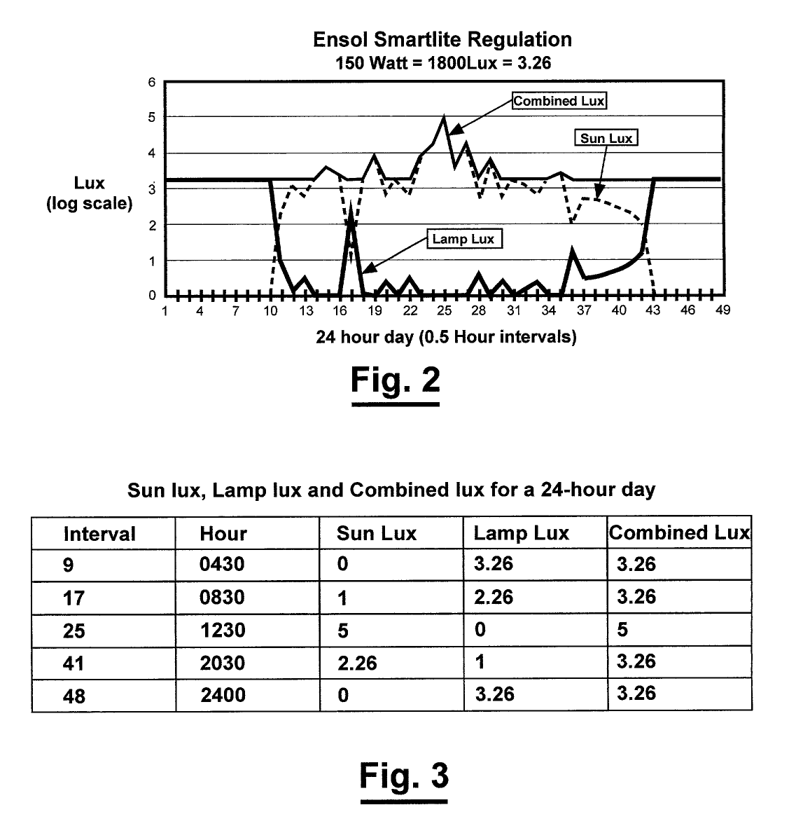

Referring now to the chart depicted in FIG. 2 and the table depicted in FIG. 3, shown therein is the relationship of natural light, artificial light, and combined natural and artificial light transmitted through the skylight 14 for a 24-hour day. In total darkness (when no natural light is incident on the first end 22 of the skylight 14), the artificial light source 18 will be set to discharge the minimum predetermined level required in the building area 12. Preferably, the control circuit 20 will be set so that the artificial light source 18 is outputting light at the maximum level of the artificial light source 18. As the natural light level from the natural light source increases to the predetermined minimum level, the level of artificial light output from the artificial light source 18 will decrease until the artificial light is completely turned off when the natural light entering the skylight exceeds the predetermined minimum level. During the day, when the natural light level falls below the minimum predetermined level, such as when a cloud passes overhead, the artificial light source 18 will turn on proportionately to produce a net combined natural light and artificial light level substantially corresponding to the predetermined minimum level.

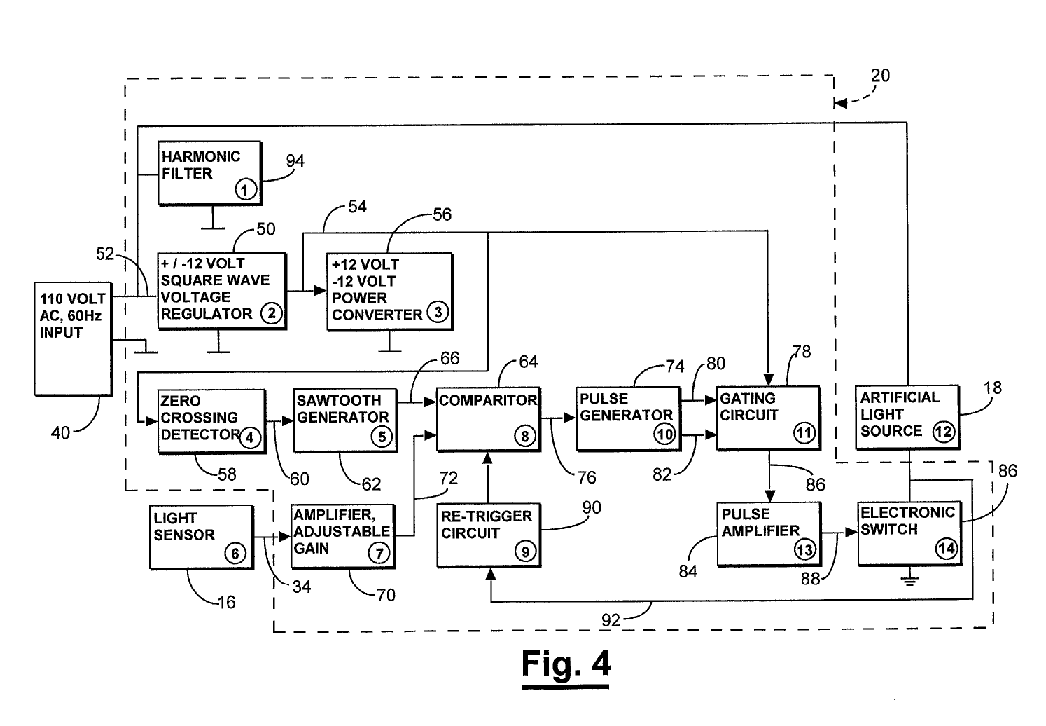

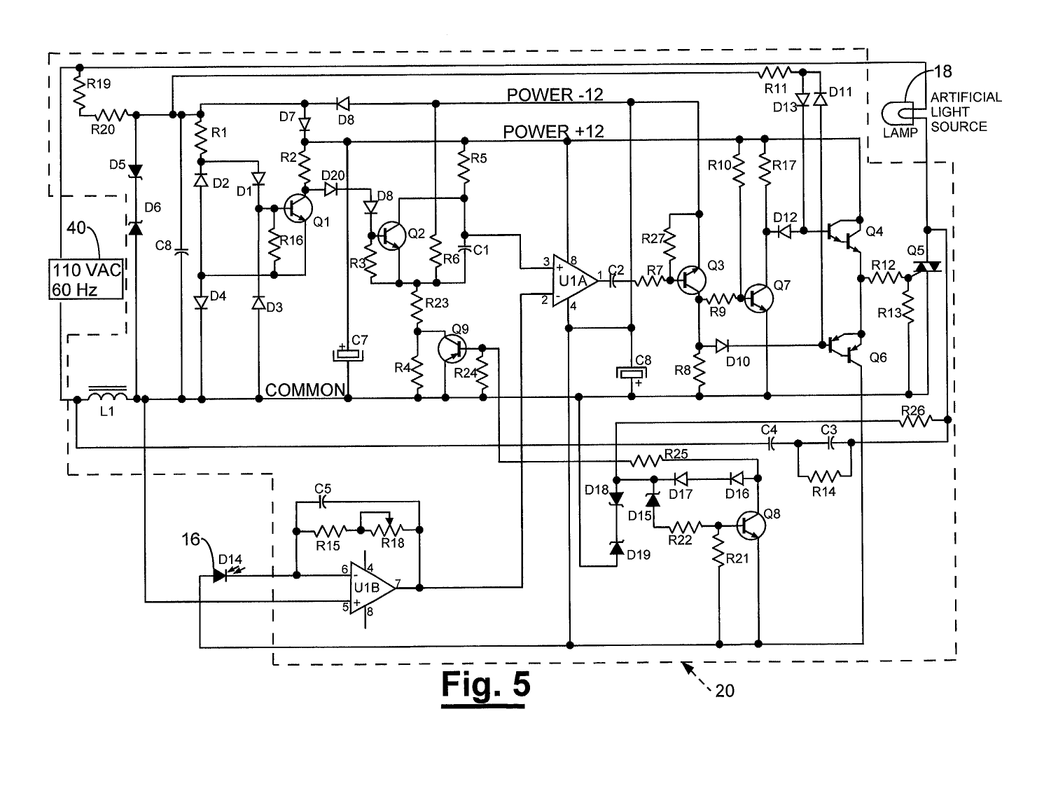

Referring now to FIGS. 4 and 5, shown therein is one embodiment of the control circuit 20 constructed in accordance with the present invention. The control circuit 20 is provided with a voltage regulator 50 which receives the power signal from the power source 40 via a signal path 52. The voltage regulator 50 converts the signal received from the power source 40 into a +/−12 volt DC square wave signal. The square wave signal is output by the voltage regulator 50 over a signal path 54, to be received by a power converter 56, a zero crossing detector 58, and a gating circuit (to be explained in more detail hereinafter).

The power converter 56 receives the signal output by the voltage regulator 50 and converts same to a +12 volt signal and a −12 volt signal, which are output to various components in the control circuit 20 as shown in FIG. 5 to provide power to the control circuit 20.

The zero crossing detector 58 receives the signal output by the voltage regulator 50 and provides a positive pulse having a predetermined period (for example, approximately 400 microseconds) at each zero crossing of the received signal. The zero crossing detector 58 outputs the positive pulse over a signal path 60 to be received by a sawtooth generator 62.

The sawtooth generator 62 receives the positive pulse generated by the zero crossing detector 58. In response thereto, the sawtooth generator 62 generates a sawtooth shaped waveform having a period equal to half the period of the frequency of the power source 40. The signal generated by the sawtooth generator 62 is output to a comparitor 64 over a signal path 66.

The control circuit 20 is provided with an adjustable gain amplifier 70 which receives the signal generated by the light sensor 16 via the signal path 34. The adjustable gain amplifier 70 permits an individual to adjust the predetermined minimum level of light to be discharged into the building area 12.

To set the gain of the adjustable gain amplifier 70, a light meter (not shown) can be utilized as follows. First, the first end 22 of the skylight 14 is covered such that no natural light enters the skylight 14. The light meter is then disposed a distance of about 1 meter, for example, from the artificial light source 18. The adjustable gain amplifier 70 is then adjusted until a maximum output from the artificial light source 18 is noted on the light meter. The first end 22 of the skylight 14 is then uncovered to permit natural light to enter into the skylight 14. The light meter is then positioned substantially the same distance from the artificial light source 18, while the adjustable gain amplifier 70, is adjusted until the artificial light source 18 just begins to glow when the light meter reading is equal to the reading which was previously recorded.

The adjustable gain amplifier 70, amplifies the signal received from the light sensor 16, and transmits such amplified signal to the comparitor 64 via a signal path 72.

The comparitor 64 compares the signals received via the signal path 66 and 72, and outputs a signal to a pulse generator 74 via a signal path 76. The pulse generator 74 then generates at least one signal, which can be transmitted to a gating circuit 78 via respective signal paths 80 and 82.

The gating circuit 78 receives the signal or signals output by the pulse generator 74 via the signal paths 80 and 82, and also receives the square wave signal generated by the voltage regulator 50 via the signal path 54. In response thereto, the gating circuit 78 outputs a signal to a pulse amplifier 84 via a signal path 86. The pulse amplifier 84 receives the signal transmitted by the gating circuit 78. In response thereto, the pulse amplifier 84 outputs a signal to an electronic switch 86 via a signal path 88 to cause the electronic switch 86 (which is illustrated as being connected in series with the artificial light source 18 as shown in FIG. 5) to control the light level generated by the artificial light source 18.

The signal output by the electronic switch 86 to control the level of the artificial light source 18 is fed back to a retrigger circuit 90 via a signal path 92. The retrigger circuit 90 serves to shift the voltage offset of the sawtooth wave form received by the comparitor 64 over the signal path 66 so as to cause the output of the comparitor 64 to retrigger after a predetermined delay of about 250 microseconds, for example, thereby producing a second pulse. The retrigger circuit 90 is necessary when the electronic switch 86 is a triac and the artificial light source 18 includes a compact dimmable fluorescent lamp.

The control circuit 20 is also provided with a harmonic filter 94 which isolates the switching harmonics of the electronic switch 86 from the power source 40.

Referring now to FIG. 5, one embodiment of the control circuit 20 will now be described. The voltage regulator 50 is formed by resistors R19, R20, and zener diodes D5 and D6. The power converter 56 is formed from diodes D7 and D8 and capacitors C7 and C8. In this case, diode D7 and capacitor C7 form the positive 12 volt DC supply, and diode D8 and capacitor C8 form the negative 12 volt DC supply.

The zero crossing detector 58 is formed by resistors R1, R2, R16, diodes D1, D2, D3, D4, and transistor Q1. The predetermined positive pulse is formed at each zero crossing at the collector of the transistor Q1.

The sawtooth generator 62 is formed by diodes D8 and D20, resistors R3 and R5, capacitor C1, and transistor Q2. The voltage across capacitor C1 is a linear ramp, which is reset to zero by the zero crossing pulse from transistor Q1 and transistor Q2. The resultant waveform at the junction of R5 and C1 is a waveform having a sawtooth shape and a period equal to half the period of the frequency of the power source 40.

The comparitor 64 includes an operational amplifier U1A. The operational amplifier U1A compares the level of the sawtooth waveform at pin 3 of the operational amplifier U1A to the voltage at pin 2 of the operational amplifier U1A. The output of the operational amplifier U1A is a pulse delayed with respect to the zero crossing voltage of the power source 40 and is directly proportional to the level of natural light received by the light sensor 16.

The “dark current” of photodiode D14 (the light sensor 16) is proportional to the natural light incident upon it. The adjustable gain amplifier 70, includes an operational amplifier U1B, a resistor R15, a capacitor CS, and a potentiometer R18. The operational amplifier U1B amplifies the current received from the light sensor 16 (D14). The resistor R15 and potentiometer R18 adjust the sensitivity (gain) of the operational amplifier U1B. The capacitor C5 forms a low pass filter with the resistors R15 and R18.

In operation, when the level of natural light received by the light sensor 16 is low, pin 7 of the operational amplifier U1B is low. In this condition, pin 1 of the operational amplifier U1A is a negative 10 volts. When the voltage at pin 3 of the operational amplifier U1A is greater than the voltage at pin 2 of the operational amplifier U1A, the operational amplifier U1A switches pin 1 from a negative 10 volts to a positive 10 volts.

The pulse generator 74 is provided with a capacitor C2, resistors R7, R27, R8, R9, R10 and R17, and transistors Q3 and Q7. When pin 1 of the operational amplifier U1A switches from negative 10 volts to positive 10 volts, the capacitor C2, resistor R7, resistor R27, and transistor Q3 differentiate the transition. The resultant negative pulse (which may be approximately 50 microseconds wide) appears across resistor R8. The resistors R9, R10, R17, and transistor Q7 form a pulse inverting switch. The collector of Q7 is a positive pulse (which also may be approximately 50 microseconds wide).

The gating circuit 78 is formed by resistor R11, diodes D10, D11, D12, and D13. The pulse amplifier circuit 84 is formed by transistors Q4 and Q6, and resistors R12 and R13. When the voltage from the power source 40 is positive, the gating circuit 78 will enable the positive pulse from transistor Q7 to be amplified by transistor Q4 of the pulse amplifier circuit 84. When the voltage from the power source 40 is negative, the gating circuit 78 will enable the negative pulse from transistor Q3 to be amplified by transistor Q6. The emitter of transistor Q4 and the collector of transistor Q6 are connected to the resistor R12. The resistor R12 sets the gate current to the electronic switch 86 (which in this example is a Triac Q5). The resistor R13 provides immunity to the Triac Q5 turn on by leakage current. The Triac Q5 is thus operated in the first and third quadrants.

The retriggering circuit 90 is formed by resistors R4, R21, R22, R23, R24, R25, and R26, transistors Q8 and Q9, diodes D16 and D17, and zener diodes D15, D18, and D19. The retriggering circuit 90 is necessary to provide two pulse firing of the Triac Q5 when the artificial light source 18 includes a compact dimmable fluorescent lamp. The voltage across zener diodes D18 and D19 is limited to +12 volts DC and −12 volts DC by the resistor R26. When the Triac main terminal is greater than+12 volts DC, transistor Q8 switches on and in turn switches transistor Q9 on. When the Triac main terminal is greater than −12 volts DC, diodes D16 and D17 are forward biased and turn on transistor Q9. The effect of this action is to shift the voltage offset of the sawtooth shaped waveform at pin 3 of the operational amplifier U1A and retrigger the output of the comparitor 64 after a predetermined delay, of approximately 250 microseconds, thereby producing a second pulse.

The harmonic filter 94 is formed by the inductor L1, capacitors C3, C4, and resistor R14. The harmonic filter 94 isolates the switching harmonics of the Triac Q5 from the power source 40.

While the implementation of the control circuit 20 is analog, the same outcome could be implemented digitally with or without a microprocessor.

The component values of the particular embodiment of the control circuit 20 set forth in FIG. 5 are shown in the following table.

| Item | Qty | References | Component Description | Value |
|---|---|---|---|---|
| 1 | 5 | Q1, Q2, Q3, Q7, | Transistor (NPN) | BC547 |
| | | Q8 | | |
| 2 | 1 | Q9 | Transistor (PNP) | BC557 |
| 3 | 1 | U1 | Operational Amplifier | LM358 |
| | | | (Dual) | |
| 4 | 1 | R18, Sensitivity | Potentiometer, 16 mm | 1 M/Linear |
| | | control | diameter | |
| 5 | 14 | D1, D2, D3, D4, | Signal Diode | 1N4148 |
| | | D7, D8, D9, D10, | | |
| | | D11, D12, D13, | | |
| | | D16, D17, D20 | | |
| 6 | 1 | Q4 | Darlington Transistor | MPSA14 |
| | | | (NPN), GP | |
| 7 | 1 | Q6 | Darlington Transistor | MPSA65 |
| | | | (PNP), GP | |
| 8 | 1 | R13 | Resistor (Metal film) | 1 K/0.25 W |
| 9 | 1 | R26 | Resistor (Metal film) | 47 K/0.5 W |
| 10 | 1 | R15 | Resistor (Metal film) | 5 K/0.25 W |
| 11 | 1 | R14 | Resistor (Metal film) | 82 R/0.25 W |
| 12 | 6 | R9, R10, R17, | Resistor (Metal film) | 10 K/0.25 W |
| | | R22, R24, R27 | | |
| 13 | 1 | R1 | Resistor (Metal film) | 12 K/0.25 W |
| 14 | 4 | D5, D6, D18, | Zener Diode | 12 V/ |
| | | D19 | | 400 mw |
| 15 | 1 | D15 | Zener Diode | 15 V/ |
| | | | | 400 mW |
| 16 | 3 | R3, R6, R7 | Resistor (Metal film) | 18 K/0.25 W |
| 17 | 1 | R8 | Resistor (Metal film) | 1 K2/0.25 W |
| 18 | 2 | R11, R25 | Resistor (Metal film) | 22 K/0.25 W |
| 19 | 1 | R2 | Resistor (Metal film) | 27 K/0.25 W |
| 20 | 1 | R16 | Resistor (Metal film) | 39 K/0.25 W |
| 21 | 1 | C1 | Ceramic capacitor | 0.1 uF/63 V |
| 22 | 2 | C5, C6 | Polyester capacitor | 0.1 uF/63 V |
| 23 | 2 | C7, C8 | Electrolytic capacitor | 100 uF/16 V |
| 24 | 2 | R4, R23 | Resistor (Metal film) | 150 R/ |
| | | | | 0.25 w |
| 25 | 1 | R12 | Resistor (Metal film) | 180 R/ |
| | | | | 0.25 W |
| 26 | 1 | C2 | Polycarbonate capacitor | 470 F/63 V |
| 27 | 2 | R19, R20 | Resistor (wirewound) | 4 K7/5 W |
| 28 | 1 | R5 | Resistor (Metal film) | 560 K/ |
| | | | | 0.25 W |
| 29 | 1 | R21 | Resistor (Metal film) | 820 R/ |
| | | | | 0.25 W |
| 30 | 1 | Artificial light | Incandescent Tungsten | 23 to 200 |
| | | source 18 | and/or Compact Philips | Watt |
| | | | Fluorescent “Earthlight” | |
| | | | (23 watt) | |
| 31 | 1 | Q5 | Triac, 500 V, 8 amp, | BT137 |
| | | | IGT = 35 mA, | |
| | | | IH = 20 mA | |
| 32 | 1 | C4 | Metalised Polyester | 0.22 uF/ |
| | | | | 250 VAC |
| 33 | 1 | L1 | Iron Powder Toroid, | 100 uH |
| | | | enamel coated, | |
| | | | 14.8 mm(OD) × | |
| | | | 8 mm(ID) × 6.35 mm(H) | |
| 34 | 1 | C3 | Metalised Polyester | 0.047 uF/ |
| | | | | 250 VAC |
| 35 | 1 | D14, | Photodiode | Telefunken |
| | | Light Sensor 16 | | BPW34 |
| 36 | 1 | | Printed Circuit Board | |
| 37 | 1 | | Metal Enclosure and | |
| | | | mounting hardware | |
| 38 | 4 | | 6.35 mm “Faston” pins | |
| Total | 67 | | | |

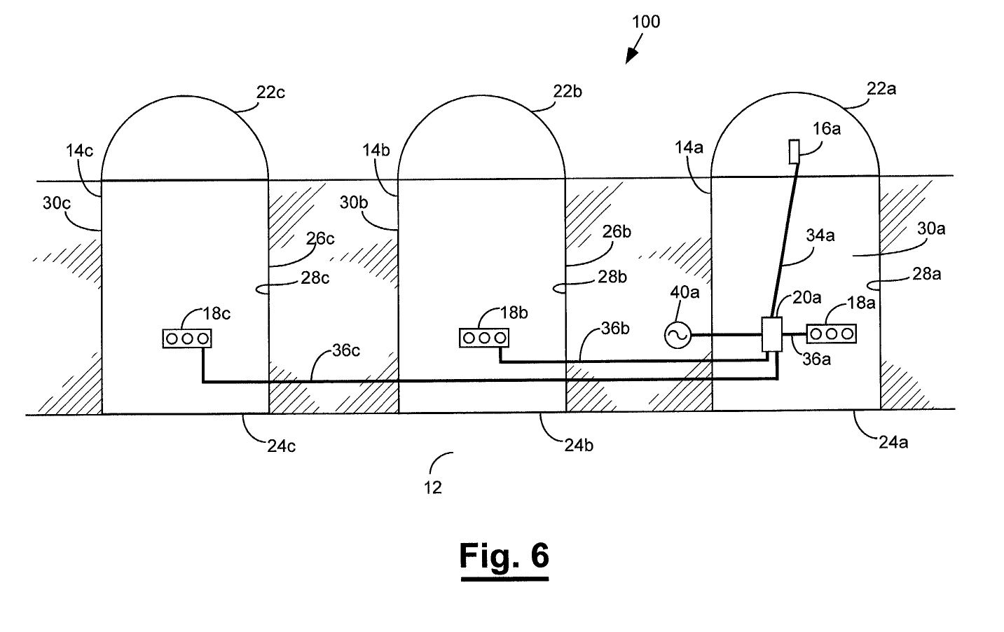

Referring now to FIG. 6, shown therein and designated by the general reference numeral 100 is a second embodiment of a natural light metering and augmentation device which is constructed in accordance with the present invention. For purposes of clarity, similar components in the device 10 and the device 100 include the same reference numeral, but different alphabetic suffixes. Such similar components will not be described in detail hereinafter for purposes of clarity.

The device 100 includes a plurality of skylights, which are designated in FIG. 6 by the reference numerals 14a, 14b and 14c. The skylights 14a, 14b and 14c are substantially similar in construction to the skylight 14, which was described hereinbefore with reference to FIG. 1.

A light sensor 16a, an artificial light source 18a and a control circuit 20a are associated with the skylight 14a in an identical manner as the light sensor 16, the artificial light source 18 and the control circuit 20 are associated with the skylight 14, as described hereinbefore with reference to FIG. 1. The light sensor 16a, the artificial light source 18a and the control circuit 20a are constructed and operated in an identical manner as the light sensor 16, the artificial light source 18 and the control circuit 20, as described hereinbefore with reference to FIG. 1. The control circuit 20a receives power from a power source 40a.

The skylights 14b and 14c are provided with respective, associated artificial light sources 18b and 18c as depicted in FIG. 6. The control circuit 20a selectively regulates the level of artificial light generated by the artificial light sources 18a, 18b and 18c via respective signal paths 36a, 36b and 36c so as to immediately maintain the combined natural light and artificial light discharged into the building area 12 at a level substantially corresponding to the predetermined minimum level when the natural light received into the skylight falls below the predetermined minimum level. The artificial light sources 18a, 18b and 18c are desirably connected in parallel to the control circuit 20a. In one embodiment, the sum of the parallel artificial light sources 18a, 18b and 18c is preferably less than about 200 watts.

Although the power output of the control circuits 20 and 20a is described herein as preferably not exceeding 200 watts, it should be understood that the control circuits 20 and 20a could be designed to supply more than 200 watts in certain instances, if desired.

Changes may be made in the embodiments of the invention described herein, or in the parts or the elements of the embodiments described herein or in the steps or sequence of steps of the methods described herein. Without departing from the spirit and/or the scope of the invention as defined in the following claims.

What is claimed is:

1. A natural light metering and augmentation device for maintaining at least a predetermined minimum level of illumination in a building area, the device comprising:
a skylight positioned to receive natural light and to discharge the natural light into the building area;
a light sensor capable of sensing the level of natural light received into the skylight and of outputting a signal indicative of the level of the natural light received into the skylight;
an artificial light source having a variable light level output, the artificial light source being positioned to discharge artificial light into the building area; and
a control circuit adapted to receive the signal indicative of the level of natural light received into the skylight, and to selectively regulate the level of artificial light generated by the artificial light source to maintain the combined natural light and artificial light discharged into the building area substantially corresponding to the predetermined minimum level when the natural light received into the skylight falls below the predetermined minimum level.

2. A natural light metering and augmentation device as defined in claim 1, wherein the control circuit continuously regulates the phase of the power transmitted to the artificial light source so as to control the level of artificial light generated by the artificial light source.

3. A natural light metering and augmentation device as defined in claim 1, wherein the control circuit is adapted to instantaneously control the level of artificial light generated by the artificial light source when signal from the light sensor indicates that the natural light received into the skylight has fallen below the predetermined minimum level.
